(19) United States
(12) Patent Application Publication
(10) Pub. No.: US 2013/0259601 A1
(43) Pub. Date: Oct. 3, 2013

(54) Low Profile Standoff With Tool Stop

(71) Applicant: Fabien Létourneau, Gatineau (CA)

(72) Inventor: Fabien Létourneau, Gatineau (CA)

(73) Assignee: Alcatel-Lucent Canada, Inc., Ottawa (CA)

(21) Appl. No.: 13/436,228

(22) Filed: Mar. 30, 2012

(51) Int. Cl. F16B 35/00; F16B 33/02; F16B 23/00

(52) U.S. Cl. 411/402; 411/378; 411/411

(57) ABSTRACT

A low profile standoff with tool stop is disclosed for attaching surfaces in fixed proximity to each other. The low profile standoff with tool stop includes a main body having a threaded bore, a threaded stem for threading a nut, and an intermediate section of narrower cross section than the main body that admits a portion of the threaded bore. The intermediate section extends within the thickness of the mounting surface while the main body stays on one side and the threaded stem extends wholly through to the opposite side of the surface. Some embodiments further comprise a tool stop on the exterior of the main body. Other embodiments dispense with the threaded stem. The low profile standoff with tool stop is particularly useful for overcoming the strength disadvantages of reduced height standoffs known in the art, and of minimizing tool head damage to the mounting surface.

### FIELD OF THE INVENTION

The invention relates to low profile standoffs and more specifically to low profile standoffs maximizing the thread purchase for mounting screws.

### BACKGROUND OF THE INVENTION

Standoffs are used to establish and maintain a required distance between two objects. A common use of standoffs in electronics technology is to act as mounting spacers between a circuit board and an enclosure.

A particular type of commonly used standoff may be seen in perspective view in FIG. 1A. The standoff has a main body 100 of a generally cylindrical shape and a main axis 102. A threaded bore 104, parallel and generally centered on the main axis 102 penetrates the main body 100. A threaded stem 106 extends, again parallel and generally centered on the main axis 102, at the opposite end of the main body 100 from the threaded bore 104. In some versions, main body 100 is provided with faceted sides for ease of coupling to wrench tool heads.

Referring now to FIG. 1B, the standoff may be seen in sectional view with main body 110; main axis 112; threaded bore 114; and threaded stem 116.

In operation the standoff is used in a manner depicted in FIG. 1C where circuit board 128 has a hole through which threaded stem 126 is inserted until main body 120 comes to rest on circuit board 128. As is obvious to those skilled in the art, the hole through circuit board 128 is sufficiently large enough to admit threaded stem 126, yet small enough to preclude main body 120 from falling through the hole. In operation a nut and possibly a washer is threaded over threaded stem 126 anchoring the resultant assembly to circuit board 128. The threaded bore in main body 120 may then accept a bolt or machine screw which can be used to secure a second circuit board (not shown) to the top of main body 120 and “stood-off” from circuit board 128.

In some applications threaded stem 126 is used to affix an appropriately threaded mechanical part, for example a heat sink, to circuit board 126, thus serving the double function of standoff and anchoring bolt.

With the increased packing density being achieved in modern circuit assemblies there is a requirement for lower profile standoffs. This presents a problem as may be seen in the section drawing of a standoff in FIG. 2. In the standoff shown in FIG. 2 main body 200 has been reduced in height above circuit board 208. This has the result of shortening the threaded length of threaded bore 204. As a certain reduced standoff height, the threaded length of threaded bore 204 provides insufficient mechanical strength to meet vibrational and shock performance requirements for the assembly. Threaded bore 204 cannot be further extended along main axis 202 because the bore will compromise the strength of threaded stem 206, and in the extremis result in the detachment and failure of stem 206, again compromising the integrity of the standoff assembly.

Therefore there is a need for a standoff of reduced height, with standard threaded dimensioning that maintains an adequate mechanical strength.

### SUMMARY OF THE INVENTION

It is an object of the invention to provide a reduced height standoff with standard threaded dimensioning that maintains adequate mechanical strength.

According to an aspect of the invention there is provided a standoff for mounting on a surface having a thickness, the standoff having a proximal end having a threaded bore; a distal end having a threaded stem generally parallel to the threaded bore; and an intermediate section between proximal and distal ends, wherein the intermediate section is narrower in cross section than the proximal end, and wherein the intermediate section is wider in cross section than the threaded stem; and wherein the threaded bore extends through the proximal end and into the intermediate section.

In some embodiments of the invention the standoff has flat sidewalls on the proximal end. In some of these embodiments the flat sidewalls are six in number and comprise a regular hexagon in cross-section.

In other embodiments of the invention the intermediate section is of length less than the thickness of the mounting surface.

According to another aspect of the invention there is provided a tool stop on the exterior of the proximal end of the standoff. In some embodiments the tool stop has a surface which precludes a driving tool from encompassing the length of the proximal end. In some of these embodiments the tool stop is a circumferential ridge around the proximal end of the standoff.

In other embodiments of this aspect of the invention the standoff has flat sides wherein the flat sides commence at the threaded bore end of the proximal end and terminate at an intermediate point along the length of the proximal end, and a tool stop is formed by a ledge at the bottom of the flat sides.

In yet other embodiments of this aspect of the invention the tool stop is a non-circumferential projection from the side surface of the proximal end. In some of these embodiments the non-circumferential projection is a nub, while in other of these embodiments the non-circumferential projection is a plurality of nubs equidistant from the bore end of the proximal end. In some of these embodiments the plurality of nubs is symmetrically disposed around the circumference of the proximal end.

In some embodiments of this aspect of the invention the threaded bore has a helical thread, while in other embodiments the threaded bore has a circumferential thread. Similarly, in some embodiments of the invention the threaded stem has a helical thread, while in other embodiments the threaded stem has a circumferential thread.

According to another aspect of the invention there is provided a standoff for mounting between a first surface having a first thickness and a second surface having a second thickness, the standoff having a first shoulder section at a first end of the standoff; a second shoulder section at the end opposite to the first end; an intermediate section between the first and second shoulder sections wherein the intermediate section is wider in cross section than the first shoulder section and wider in cross section than the first shoulder section; and wherein a threaded bore extends continuously through the first shoulder section, and the intermediate section, and the second shoulder section.

In some embodiments of this aspect of the invention the first should section is of length less than the first thickness.

In some embodiments of this aspect of the invention the threaded bore has a helical thread, while in other embodiments the threaded bore has a circumferential thread.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which like reference numbers are used to represent like elements, and:

FIG. 1A illustrates a perspective view of a standoff according to the prior art;

FIG. 1B illustrates a sectional view of the standoff of FIG. 1A;

FIG. 1C illustrates an elevation view of the standoff of FIG. 1A in mounted position on a circuit board;

FIG. 2 illustrates a sectional view of a reduced height standoff in position on a circuit board;

FIG. 3A illustrates a sectional view of a reduced height standoff in position on a circuit board according to an embodiment of the invention;

FIG. 3B illustrates an elevation view of the standoff of FIG. 3A in mounted position on a circuit board;

FIG. 4A illustrates an elevation view of a reduced height standoff according to an embodiment of the invention in mounted position on a circuit board and having adjacent components;

FIG. 4B illustrates an elevation view of a reduced height standoff according to an alternative embodiment of the invention in mounted position on a circuit board and having adjacent components;

FIG. 5 illustrates an elevation view of a reduced height standoff according to another embodiment of the invention in mounted position on a circuit board and having adjacent components;

FIG. 6 illustrates an elevation view of a reduced height standoff according to yet another embodiment of the invention in mounted position on a circuit board and having adjacent components; and

FIG. 7 illustrates a sectional view of a reduced height standoff in position on a circuit board according to an alternative embodiment of the invention.

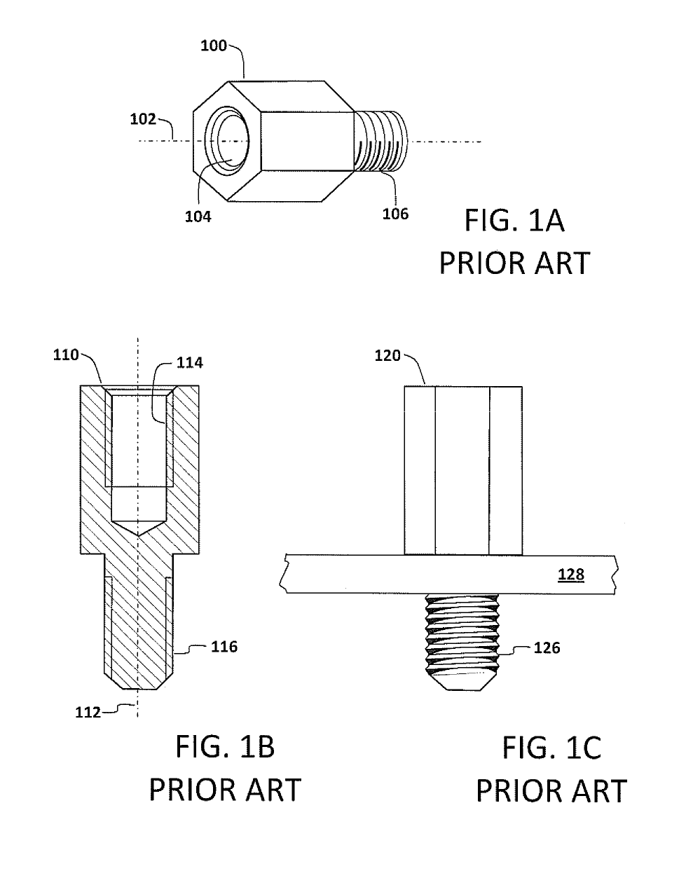

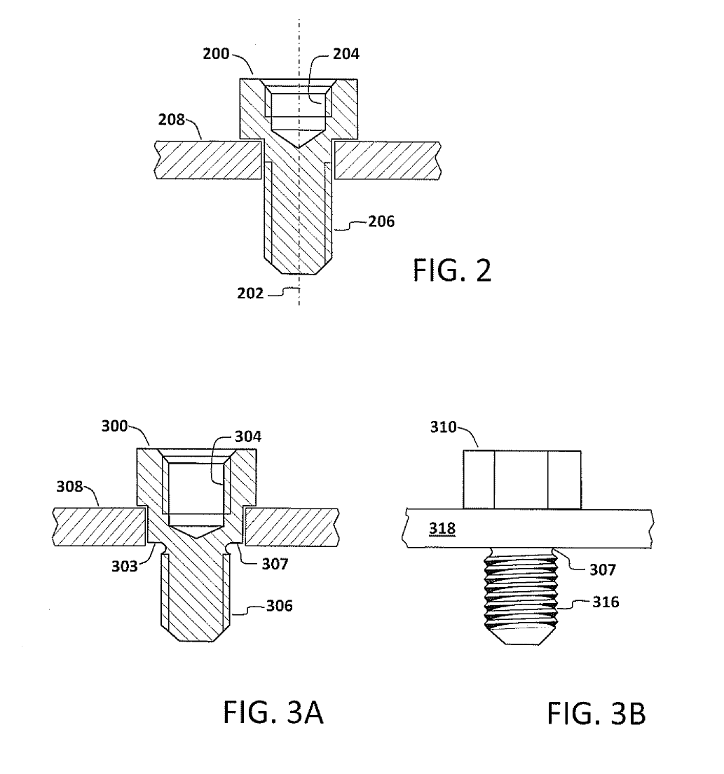

### DETAILED DESCRIPTION

In the following description, references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Those of ordinary skill in the art, with the included descriptions, will be able to implement appropriate functionality without undue experimentation.

In the following description, like reference numbers refer to similar features.

Referring to now to FIG. 3A there may be seen an embodiment of the invention in sectional view mounted on circuit board 308. According to this embodiment, main body 300 has a threaded board 304, and a threaded stem 306. Below main body 300, shoulder section 303 of narrower cross-sectional width than main body 300 and wider cross-sectional width than threaded stem 306 provides a zone wherein threaded bore 304 may be extended. The extension of threaded bore 304 provides additional threads for the top-side faster, while the increased cross-sectional width as compared to threaded stem 306 provides for sufficient material strength at the lower point of threaded bore 304.

In some versions of the embodiment, shoulder section 303 is dimensioned so that in position it does not penetrate fully through circuit board 308, stopping short of the lower surface as shown at gap 307. The gap 307 precludes any interference between shoulder section 303 and the nut and washer assembly normally affixed to threaded stem 306, as such interference could prevent adequate tightening of the nut. Alternatively, shaped washers such as stepped washers or concave washers known in the art could be used to bridge any penetration of shoulder section 303 through circuit board 308, thereby allowing operation without the presence of gap 307.

Referring now to FIG. 3B, there may be seen the standoff of FIG. 3A in elevation view, having main body 310, circuit board 318; threaded stem 316; and shoulder section gap 317. The standoff in this embodiment has faceted sides. A preferred version has six sides to accommodate hexagonal nut drivers.

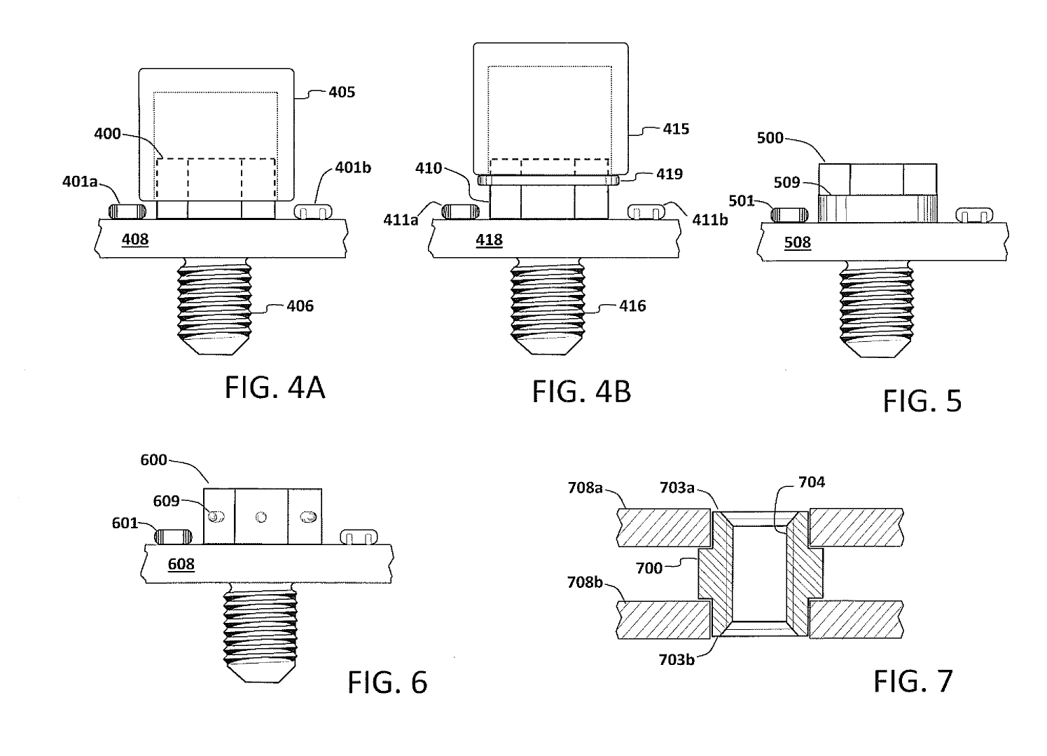

Referring now to FIG. 4A there may be seen a low profile standoff in accordance with an embodiment of the invention mounted in circuit board 408. Adjacent to the standoff are components 401a and 401b. Driving tool head 405 fits over the top of the faceted main body 400 of the standoff, preparatory to anchoring the main body while a nut or nut and washer combo is applied to the threaded stem 406. As may be seen in FIG. 4A, driving tool head 405 has the possibility of descending and impacting components 401a and 401b, or of causing abrasion damage to the surface of circuit board 408.

Referring now to FIG. 4B there may be seen an alternative embodiment of the invention. As in FIG. 4A a low profile standoff in accordance with an embodiment of the invention is mounted in circuit board 418. Adjacent to the standoff are components 411a and 411b. Driving tool head 415 fits over the top of the faceted main body 410 of the standoff, preparatory to anchoring the main body while a nut or nut and washer combo is applied to the threaded stem 416. This embodiment further comprises tool stop 429 which serves to limit the depth that tool head 415 may encompass main body 410. In this embodiment tool stop 419 comprises a ridge or ring extending outward from the sides of main body 410 to an extent that interrupts the downward motion of tool head 425. The presence of the tool stop prevents tool head 425 from coming into contact with either components 411a and 411b, or with the surface of circuit board 418. The net result is to allow closer placement of components to the standoff, thus realizing the use of more of the surface of circuit board 418. As well, the prevention of abrasion damage to the surface of circuit board 418 enhances the reliability of the circuit board and circuit traces thereon.

Referring now to FIG. 5, there may be seen an alternative embodiment of the invention which also possesses a tool stop feature. In this embodiment, main body 500 has a cylindrical form at its base portion adjacent to circuit board 508, and the faceted sides are formed via a relieving of the cylinder walls to define the facets. The bottom ledge of the relieved portions at 509 acts as the bearing surface for tool stop purposes. Note, the term “relieving” refers to the absence of material as opposed to implying the specific type of operation forming the relief. In practice any of the embodiments of the invention could be formed by machining, casting, forging, molding, or a combination thereof.

Referring now to FIG. 6, there may be seen yet another embodiment of the invention which also possesses a tool stop feature. According to this embodiment which has the low profile standoff inserted in circuit board 608 and having adjacent component 601, the main body 600 of the standoff has a series of projections 609 extending outward therefrom. These projections may take the form of pins or nubs. In quantity the number of nubs would be sufficient to withstand the expected forces from use of a tool head, a quantity that would vary dependent upon the strength of the material from which the standoff was made. Standoffs are commonly manufactured in plastic, nylon being a common material, as well as metals, brass being a common material. The metal standoffs have the advantage of increased strength whereas the plastic standoffs possess an insulative property. In preferred embodiments the projections are arranged symmetrically around the main axis of the standoff so as to minimize the generation of lateral forces as the tool head comes to bear on the standoff.

Referring now to FIG. 7, there may be seen a sectional view of yet another embodiment of the invention. According to this embodiment which has the main body 700 of the low profile standoff inserted between circuit boards 708a and 708b, there may be seen a shoulder section 703a at one end of main body 700 and shoulder section 703b at the other end of main body 700. In some embodiments the length of shoulder section 703a is less than the thickness of circuit board 708a, and in other embodiments the length of shoulder section 703b is less than the thickness of circuit board 708b. This embodiment represents a form of standoff characterized as type “female-female” representing the apertures at each end of the main body 700 produced by the threaded bore 704. By way of contrast the previously described embodiments would be characterized as “female-male” embodiments according to the aperture produced by the threaded bore at one end and the threaded stem at the other end.

In the various embodiments described, the term “threaded” may refer to a helical thread which would engage a bolt in the case of the threaded bore, or would engage a nut in the case of the threaded stem; or alternatively could refer to a circumferential thread of the kind intended for engagement with a push-on barbed fitting.

In the various embodiments described, the threaded bore and threaded stem are generally parallel to the main axis of the standoff and generally collinear with the main axis. In certain applications it may be advantageous to offset either the threaded stem or the threaded bore, and so nothing in the foregoing discussion is to be construed to preclude this. In general however, for both ease of manufacturing and ease of fastening, the threaded bore and threaded stem will be generally coaxial with the main axis of the main body of the standoff.

In the various embodiments described, the low profile standoff has been described in relation to an application in relation to a circuit board. The circuit board is representative of any appropriate surface in which the low profile standoff would be used. Other typical, but not limiting examples of surfaces in which the low profile standoff could find application include circuit board faceplates, electronics enclosures, and subcircuit assemblies.

According to the foregoing, various exemplary embodiments provide for a standoff of reduced height, with standard threaded dimensioning that maintains an adequate mechanical strength. In particular by providing a shoulder section beneath the main body of the standoff, the depth of the threaded bore may be increased and the attachment area of the threaded stem not substantially weakened. In addition, the provision of a tool stop integral to the main body of the low profile standoff acts to prevent damage to the surface upon which the low profile standoff is mounted, and provides the opportunity to place components in closer proximity to the standoff.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A standoff for mounting on a surface having a thickness, the standoff comprising:
a proximal end having a threaded bore;
a distal end having a threaded stem generally parallel to said threaded bore; and
an intermediate section between proximal and distal ends,
wherein said intermediate section is narrower in cross section than said proximal end, and
wherein said intermediate section is wider in cross section than said threaded stem; and
wherein said threaded bore extends through said proximal end and into said intermediate section.

2. A standoff as claimed in claim 1 further comprising:
flat sidewalls on said proximal end.

3. A standoff as claimed in claim 2 wherein said flat sidewalls are six in number and comprise a regular hexagon in cross-section.

4. A standoff as claimed in claim 1 wherein said intermediate section is of length less than said thickness.

5. A standoff as claimed in claim 1 further comprising:
a tool stop on the exterior of said proximal end.

6. A standoff as claimed in claim 5 wherein said tool stop comprises a surface which precludes a driving tool from encompassing the length of said proximal end.

7. A standoff as claimed in claim 6 wherein said tool stop comprises a circumferential ridge around said proximal end.

8. A standoff as claimed in claim 2 wherein said flat sides commence at the threaded bore end of said proximal end and terminate at an intermediate point along the length of said proximal end, and
wherein a tool stop is formed by a ledge at the bottom of said flat sides.

9. A standoff as claimed in claim 6 wherein said tool stop comprises a non-circumferential projection from the side surface of said proximal end.

10. A standoff as claimed in claim 9 wherein said non-circumferential projection comprises a nub.

11. A standoff as claimed in claim 9 wherein said non-circumferential projection comprises a plurality of nubs equidistant from the bore end of said proximal end.

12. A standoff as claimed in claim 11 wherein said plurality of nubs is symmetrically disposed around the circumference of said proximal end.

13. A standoff as claimed in claim 1 wherein said threaded bore comprises a helical thread.

14. A standoff as claimed in claim 1 wherein said threaded bore comprises a circumferential thread.

15. A standoff as claimed in claim 1 wherein said threaded stem comprises a helical thread.

16. A standoff as claimed in claim 1 wherein said threaded stem comprises a circumferential thread.

17. A standoff for mounting between a first surface having a first thickness and a second surface having a second thickness, the standoff comprising:
a first shoulder section at a first end of said standoff;
a second shoulder section at the end opposite to said first end;
an intermediate section between said first and second shoulder sections,
wherein said intermediate section is wider in cross section than said first shoulder section and wider in cross section than said first shoulder section; and
wherein a threaded bore extends continuously through said first shoulder section, and said intermediate section, and said second shoulder section.

18. A standoff as claimed in claim 17 wherein said first shoulder section is of length less than said first thickness.

19. A standoff as claimed in claim 17 wherein said threaded bore comprises a helical thread.

20. A standoff as claimed in claim 17 wherein said threaded bore comprises a circumferential thread.
